(19) United States
(12) Patent Application Publication
(10) Pub. No.: US 2015/0314821 A1
(43) Pub. Date: Nov. 5, 2015

(54) SEAT POST FOR ACCOMMODATING A SEAT SADDLE

(71) Applicant: Derby Cycle Werke GmbH, Cloppenburg (DE)

(72) Inventor: Thadeus TISCH, Stuttgart (DE)

(21) Appl. No.: 14/703,195

(22) Filed: May 4, 2015

(30) Foreign Application Priority Data
May 3, 2014 (DE) 202014003745.0

(51) Int. Cl. B62J 1/08

(52) U.S. Cl. CPC B62J 1/08

(57) ABSTRACT

A seat post is provided for accommodating a seat saddle and joining the latter with the structure of a vehicle, in particular with the frame of a bicycle. The seat post has at least one shaft. The shaft is designed as a single piece out of at least one tube section, and out of one section with at least two partial shaft sections spaced apart from each other.

### BACKGROUND OF THE INVENTION

1. Field of the Invention

The invention relates to a seat post for accommodating a seat saddle and joining the latter with the structure of a vehicle, in particular with the frame of a bicycle, comprising at least one shaft.

2. Brief Discussion of the Related Art

In two-wheeled vehicles, the user is provided with handlebars and a seat saddle for using the vehicle. The user can sit on the seat saddle, and place his or her hands on the free ends of the handlebars. A generic seat post is provided for the seat saddle, which joins the seat saddle with the structure of the vehicle, in a bicycle with the bicycle frame. The seat post essentially consists of the shaft, which can be inserted a ways into the structure of the vehicle, and fixed in place there by applying a clamping force, while the seat saddle is arranged on the upper free end of the shaft.

In addition to rigid shafts, a plurality of different spring-mounted shafts have been proposed for seat posts. Known shafts in part have a multi-part design, so as to form spring and damping elements therewith. Spring-mounted seat posts with parallelogram mechanics have also been proposed already, as has the insertion of elastomer blocks in the progression of a shaft in DE 200 15 777 U1.

Seat posts with inserted spring or damping elements have a correspondingly complicated design. A seat post with parallelogram mechanics also exhibits several components and is correspondingly complicated and expensive.

### SUMMARY OF THE INVENTION

The object of the invention is to indicate a seat post of the kind mentioned at the outset, which exhibits a damping feature while retaining a one-piece shaft.

This object is achieved according to the invention by having the shaft be designed as a single piece out of at least one tube section, and out of one section with at least two partial shaft sections spaced apart from each other.

The shaft provided in the seat post according to the invention does not consist of several parts, but rather remains in a single piece. However, it does exhibit a special section in which the shaft is comprised of partial shaft sections. These partial shaft sections are spaced apart from each other. Since at least two partial shaft sections form one section of the otherwise one-piece shaft, the partial shaft sections have smaller dimensions than the shaft itself. As a result of the smaller dimensions, in particular a diminished cross sectional area, a desired flexible area arises for the partial shaft sections. The shaft of the seat post can yield more readily to encountered loading forces in this area than in the other areas designed as tube sections. Furthermore, there are suspension properties that are achieved by the selected structure of the material and seat post. This can be a fibrous structure if the seat post consists of a fibrous material.

The seat post according to the invention has a simple structural design, while still making it possible to introduce a distinct spring effect into the progression of its shaft.

A first further development of the invention provides two partial shaft sections, which are placed in a V shape relative to each other. The V configuration increases the distance between the partial shaft sections in certain areas. This yields an installation space here that can be used for optionally attaching a technical device. For example, a technical device can be a taillight. However, other devices can also be incorporated, such as an accelerometer or backup camera.

In order to accommodate such a technical device, it can be provided that an elastomer be additionally situated in the space between both partial shaft sections. This is used to fix the technical device in place.

In another further development of the invention, the preferably two partial shaft sections are framed by tube sections. As a consequence, both free ends of the partial shaft sections are again encapsulated by a tube section. The partial shaft sections thus laterally border an eye in the progression of the shaft.

In a next further development of the invention, a tube section arranged above the partial shaft sections is given a platform-like design to accommodate connecting means for the seat saddle. The section of the shaft with the partial shaft sections must be formed outside the area of the seat post to be inserted into the structure of the vehicle. As a result, it is advantageous for the section with the partial shaft sections to be situated directly underneath the seat saddle. Above the partial shaft sections, the tube section can then readily be designed like a platform to accommodate the seat saddle, wherein correspondingly standardized connecting means can also be used with the seat post according to the invention.

A next further development of the invention provides that the elastomer be designed as an annular component in the section between the partial shaft sections, wherein the annular component abuts against and envelops the technical device. The annular component of the elastomer can tightly abut against the facing interior sides of the partial shaft sections, and further abuts against and envelops an inserted technical device.

The technical device can preferably exhibit elements of a lighting device, for example batteries and LED's. Since the area with the partial shaft sections is preferably arranged directly under the seat saddle situated on the seat tube, this area is also suitable for accommodating a taillight for a bicycle, for example.

### BRIEF DESCRIPTION OF THE DRAWINGS

The drawing presents an exemplary embodiment of the invention, from which additional inventive features are derived. Shown on:

FIG. 1 is a first perspective partial view of a seat post according to the invention;

FIG. 2 is another perspective partial view of the seat post according to FIG. 1; and

FIG. 3 is a partial view of the seat post according to FIG. 1.

### DETAILED DISCUSSION OF THE PREFERRED EMBODIMENTS

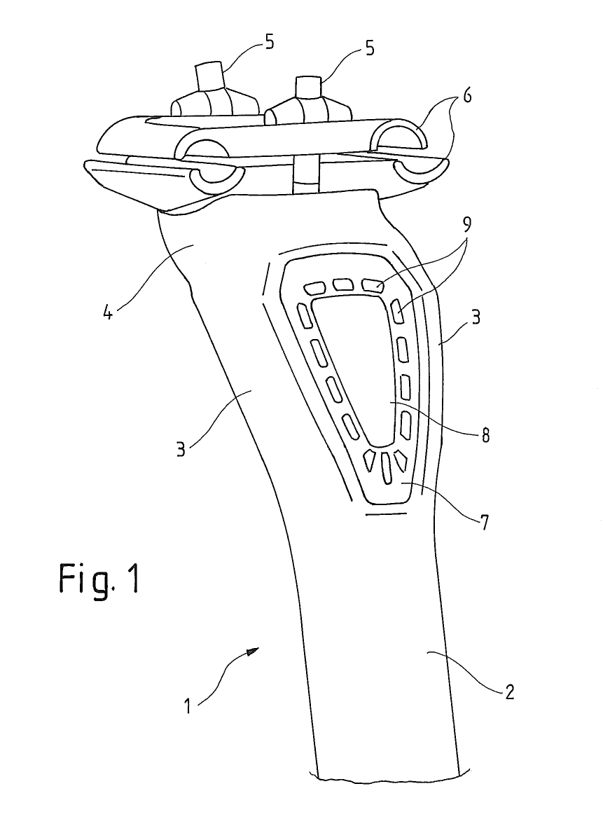

The seat post on FIG. 1 exhibits a shaft 1. The shaft 1 has a tube section 2 along with two partial shaft sections 3 above the tube section 2. Provided above the partial shaft sections 3 is another platform-like tube section 4, upon which clamping elements 6 for attaching a seat saddle are arranged with the help of screws 5.

The two partial shaft sections 3 are arranged in a slight V configuration relative to each other. They are joined with the tube sections 2, 4 of the shaft 1 as a single piece. An installation space is formed between both partial shaft sections 3, and filled by an elastomer 7 along with a technical device 8. The elastomer 7 is designed as an annular component, wherein this annular component envelops the device 8. Openings 9 are also introduced into the elastomer 7.

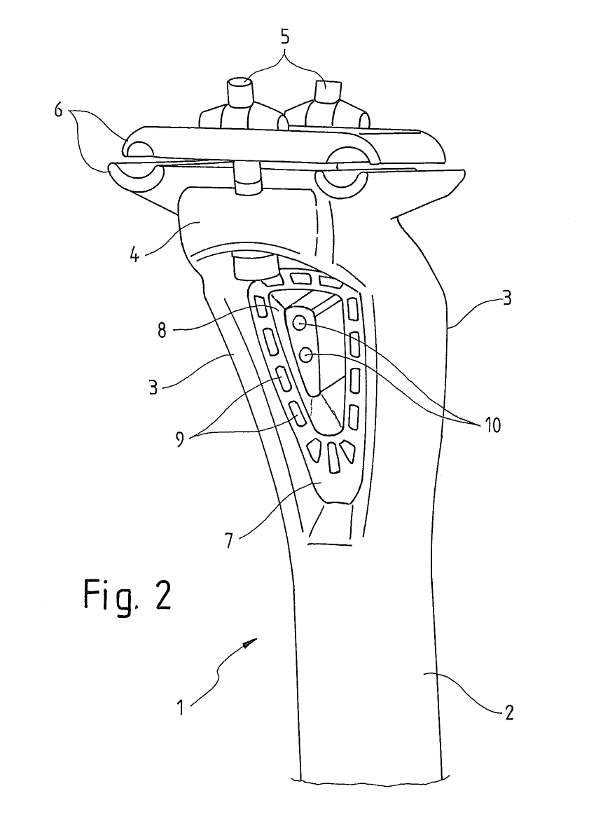

These openings 9 are also visible on FIG. 2, and extend through the entire elastomer 7. FIG. 2 additionally shows that LED's 10 of a lighting device are arranged in the device 8.

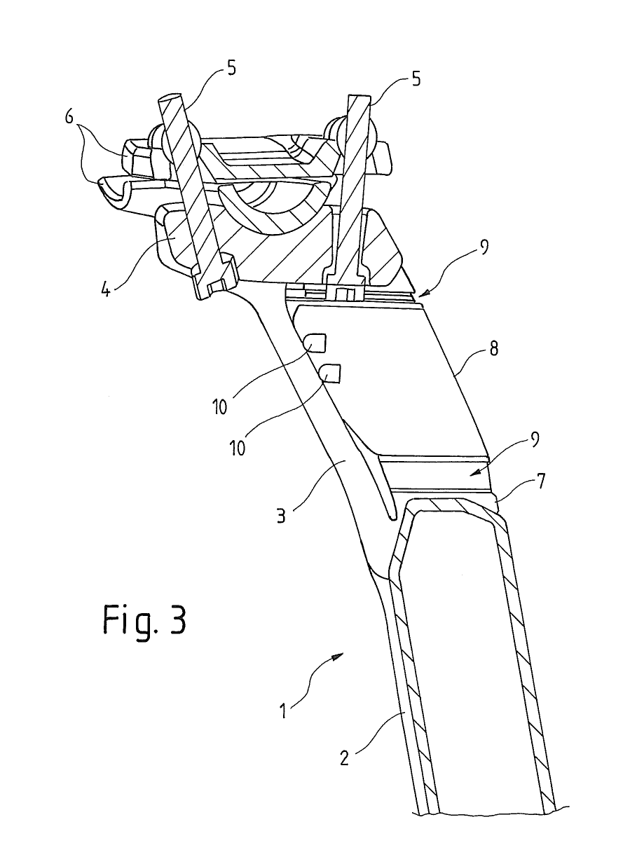

FIG. 3 once again illustrates the allocation of elastomer 7 with an opening, device 8 and LED's 10. The device 8 can accommodate batteries, switching elements, light-sensitive elements and the like for the LED's 10.

All features enumerated in the above specification and in the claims can be combined with the features in the independent claim however desired. As a consequence, the disclosure of the invention is not limited to the described or claimed feature combinations; rather, all sensible feature combinations within the framework of the invention must be regarded as disclosed.

1. A seat post for accommodating a seat saddle and joining the latter with the structure of a vehicle, in particular with the frame of a bicycle, comprising at least one shaft,
wherein the shaft is designed as a single piece out of at least one tube section, and out of one section with at least two partial shaft sections spaced apart from each other.

2. The seat post according to claim 1, wherein two partial shaft sections are provided and placed in a V shape relative to each other.

3. The seat post according to claim 2, wherein the partial shaft sections are framed by tube sections.

4. The seat post according to claim 3, wherein a tube section arranged above the partial shaft sections is given a platform-like design to accommodate connecting means for the seat saddle.

5. The seat post according to claim 1, wherein at least one technical device can be arranged between the partial shaft sections.

6. The seat post according to claim 1, wherein an elastomer designed as an annular component can be arranged between the partial shaft sections.
